(19) United States
(12) Patent Application Publication
(10) Pub. No.: US 2026/0316603 A1
(43) Pub. Date: Oct. 15, 2026

(54) INTEGRATED WIRELESS BASE STATION AND EV CHARGING STATION

(71) Applicant: Dimitrios Lalos, St. Charles, IL (US)

(72) Inventor: Dimitrios Lalos, St. Charles, IL (US)

(21) Appl. No.: 19/478,202

(22) PCT Filed: Apr. 29, 2024
(86) PCT No.: PCT/US2024/026737

§ 371 Date: Oct. 23, 2025

Related U.S. Application Data
(60) Provisional application No. 63/498,579, filed on Apr. 27, 2023.

(51) Int. Cl. B60L 53/12; B60L 53/31; B60L 53/51; B60L 53/66; H02J 7/35; H02M 3/335; H04L 12/14; H04W 4/24; H04W 4/44; H04W 84/12

(52) U.S. Cl. CPC B60L 53/12; B60L 53/31; B60L 53/51; B60L 53/66; H02J 7/35; H02M 3/33553; H04L 12/1453; H04W 4/24; H04W 4/44; B60L 2210/10; B60L 2210/30; H02J 2207/20; H04W 84/12

(57) ABSTRACT

A system includes a housing including a base configured to couple with a ground anchor and a support frame coupled with and extending upward from the base. An electric vehicle charger is housed by a first interior portion of the housing. A wireless base station is housed by a second interior portion of the housing. An electrical power supply system is configured to supply power to the electric vehicle charger via a first conductor and to supply power to the wireless base station via a second conductor.

### CROSS-REFERENCE TO RELATED APPLICATIONS

The present application claims the benefit of and priority to U.S. Application No. 63/498,579, filed Apr. 27, 2023, and the same is incorporated herein by reference.

### TECHNICAL FIELD

The present application relates to integrated wireless base station and electrical vehicle (EV) charging station apparatuses, methods, systems, and techniques.

### BACKGROUND

A number of wireless base station have been proposed. Separately, a number of electrical vehicle (EV) chargers have been proposed. Conventional approaches suffer from a number of disadvantages, drawbacks, limitations, and shortcomings, including those respecting infrastructure footprint, energy efficiency, limited functionality, and others. One example shortcoming of such conventional approaches relates the need for an EV charging station to utilize a communications link to accomplish the credit card verification to activate the charging system and service. Conventional approaches typically utilize with fiber-optic lines and connections brought out to an EV charger. Typically, since multiple EV charging stations exist in the same location, multiple wired connections will exist between the stations. This adds to the complexity and expense of building such facilities including, for example, trenching fiber from an existing fiber point of presence (POP) to the location where the EV charging stations are located which is an increasingly complex and costly proposition as distance from an EV charging station to a POP increases. Additional example shortcomings of such conventional approaches relate the need for an EV charging station to utilize buried communication lines (typically buried fiber optic cabling or other physical communication lines) running to a plurality of charging facility locations. Such footprints impose a substantial excavation and construction burden and limits the available locations at which EV charging stations may be provided. For example, the ability to run buried communication lines may be limited by existing surface and subterranean infrastructure (e.g., roads, buildings, existing gas, water, sewer and other utility infrastructure, and other potential obstacles). The geology and excavatability of a given location may also posed additional obstacles. Environmental, permitting, and zoning restrictions may pose further obstacles. There remains a significant unmet need for the apparatuses, methods, systems, and techniques disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### BRIEF DESCRIPTION OF THE DRAWINGS

FIG. 1 is partially schematic view illustrating certain aspects of an example integrated wireless base station and electrical vehicle (EV) charging station.

FIG. 1A is partially schematic view illustrating certain aspects of an alternative embodiment of the example integrated wireless base station and EV charging station of FIG. 1.

FIG. 2 is a schematic diagram illustrating certain aspects of an example electrical system for an integrated wireless base station and EV charging station.

FIG. 3 is a schematic diagram illustrating certain aspects of an example electrical system for an integrated wireless base station and EV charging station.

FIG. 4 is a schematic diagram illustrating certain aspects of an example electrical system for an integrated wireless base station and EV charging station.

FIG. 5 is a schematic diagram illustrating certain aspects of an example electrical system for an integrated wireless base station and EV charging station.

FIG. 6 is a schematic diagram illustrating certain aspects of an example electrical system for an integrated wireless base station and EV charging station.

FIG. 7 is a perspective view illustrating certain aspects of an example integrated wireless base station and EV charging station.

FIG. 8 is a schematic diagram illustrating certain aspects of an example electrical system for an integrated wireless base station and EV charging station.

FIGS. 9 and 10 are partially schematic views illustrating certain aspects of another example integrated wireless base station and EV charging station.

FIGS. 11 and 12 are partially schematic views illustrating certain aspects of another example integrated wireless base station and EV charging station.

FIG. 13 is a partially schematic views illustrating certain aspects of another example integrated wireless base station and EV charging station.

### DETAILED DESCRIPTION OF EXAMPLE EMBODIMENTS

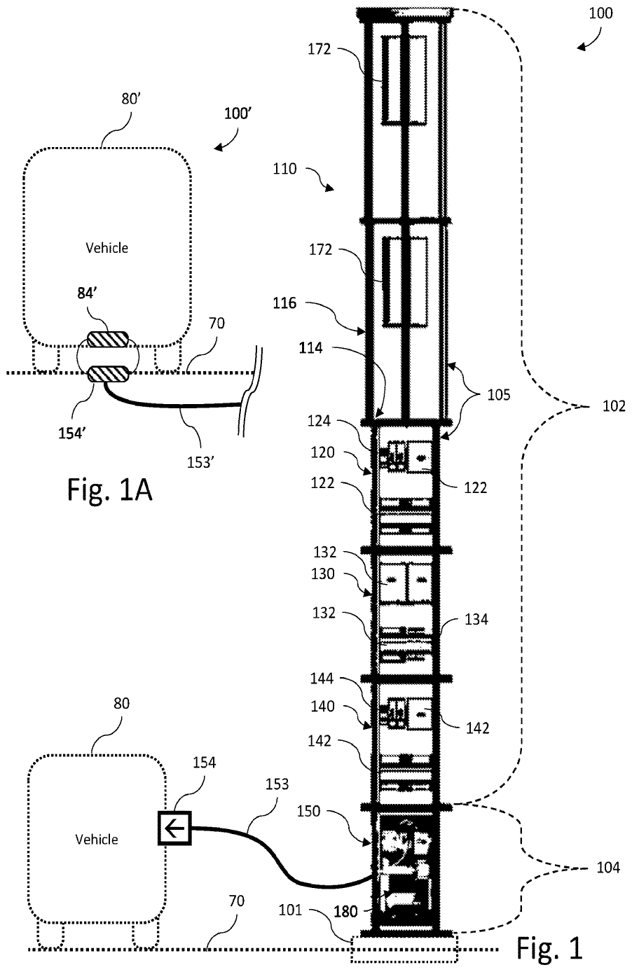

Referring now to the figures and with initial reference to FIG. 1, there is illustrated an example integrated wireless base station and electric vehicle (EV) charging station system 100 (also referred to herein as system 100). In the illustrated example, system 100 includes a housing 110 comprising a base 112, a support frame 114 coupled with and extending upward from the base 112. System 100 may include one or more exterior shell sections or panels 116 coupled with and covering one or more areas of the support frame 114. Support frame 114 may be operatively coupled with and supported by a ground anchor 101 which may, in turn, be fixedly coupled with an underlying grounds surface 70. It shall be appreciated that the housing 110, base 112, support frame 114, and exterior shell sections or panels 116, which are operatively coupled with and supported by a ground anchor 101 comprise one example of a tower according to the present disclosure which may contain and/or be operatively coupled with a plurality of components including, for example, communication components (including fiber-based, wire-based, and/or wireless communication components), computing components, EV charging components, and various combinations thereof. It shall be further appreciated that the term tower connotes vertically extending structures of various scales and heights such as scales and heights on the order of so-called small cell sites including, for example, micro, nano, pico, and femto cell sites, as well as tower structures of greater scale or in principle lesser scale and height.

A charger 180 is housed by a first interior portion 104 of the housing 110. Charging connector 154 is conducted coupled with charger 180 via charging cable 153 and is configured to be operatively coupled with an electric vehicle (EV) 80 to effectuate charging of a battery thereof (typically provided as a battery pack). In the illustrated example, charger 180 is contained in a single compartment 150 of the housing 110. In other embodiments, charger 180 may be housed by the housing 110 in other manners, for example, in more than one compartment.

A wireless base station is housed by a second interior portion 102 of the housing 110 which may, in turn, comprise multiple compartments 105. In the illustrated example, the wireless base station comprises one or more antenna 172, one or more wireless base station power supplies 122, 132, 142, and one or more cellular radio components 124, 134, 144. In the illustrated example, wireless base station power supply 142 and cellular radio components 144 are contained within a compartment 140 of housing 110. In other embodiments, these components may be housed by the housing 110 in other manners as will occur to one skilled in the art with the benefit and insight of the present disclosure. The compartment 140 may be separately and independently secured accessible from the exterior of housing 110.

In the illustrated example, wireless base station power supply 132 and cellular radio components 134 are contained within a compartment 130 of housing 110. In other embodiments, these components may be housed by the housing 110 in other manners as will occur to one skilled in the art with the benefit and insight of the present disclosure. The compartment 140 may be separately and independently secured accessible from the exterior of housing 110.

In the illustrated example, wireless base station power supply 122 and cellular radio components 124 are contained within a compartment 120 of housing 110. In other embodiments, these components may be housed by the housing 110 in other manners as will occur to one skilled in the art with the benefit and insight of the present disclosure. The compartment 140 may be separately and independently secured accessible from the exterior of housing 110.

It shall be appreciated that system 100 is an example of a freestanding integrated wireless base station and vehicle charger wherein the wireless base station and vehicle charger share a common footprint and a common ground anchor. It shall be further appreciated that system 100 is an example of an integrated wireless base station and vehicle charger wherein the wireless base station and vehicle charger share a common external power source. It shall be further appreciated that system 100 is an example of an integrated wireless base station and vehicle charger comprising an electrical power supply system configured to supply power to the electric vehicle charger via a first conductor and to supply power to the wireless base station via a second conductor. It shall be further appreciated that system 100′ may further comprise or may be associated with the components, systems, features, attributes, and environment as described and illustrated in connection with system 200, system 300, system 400, system 500, system 600, and/or system 700.

With reference to FIG. 1A, there is illustrated an alternative embodiment of a system 100′ of the example integrated wireless base station and EV charging station of FIG. 1. In the alternative embodiment 100′ vehicle 80′ is adapted wireless inductive charging via inductive charger portion 84′. Inductive charger portion 154′ may be provided instead of or in addition to charging connector 154 and may be conducted coupled with charger 180 via charging cable 153′. It shall be further appreciated that system 100′ may further comprise or may be associated with the components, systems, features, attributes, and environment as described and illustrated in connection with system 200, system 300, system 400, system 500, system 600, and/or system 700.

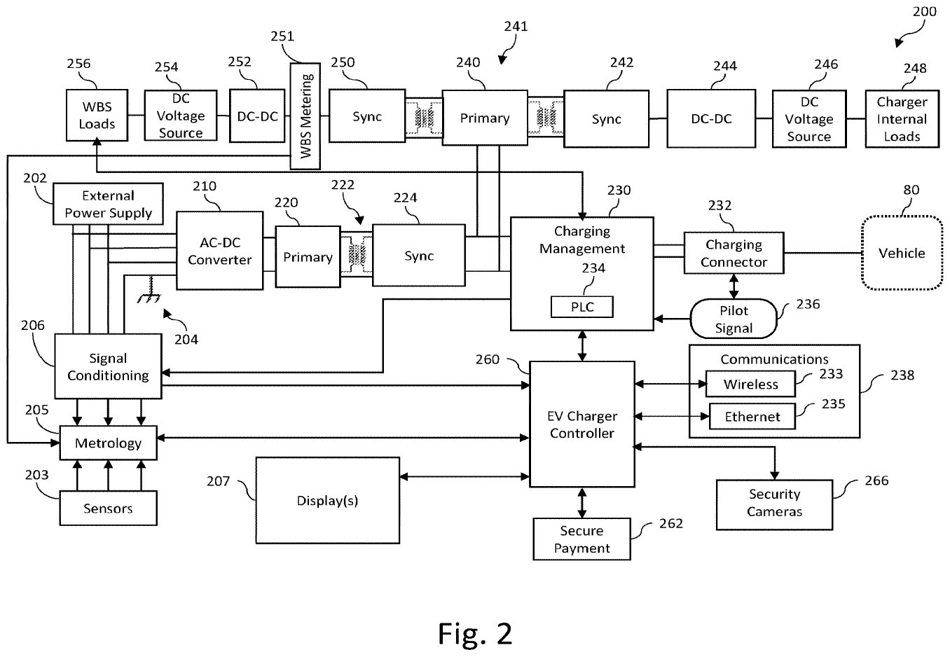

With reference to FIG. 2, there is illustrated an example electrical power supply system 200 (also referred to herein as system 200) configured to supply power to one or more loads of an electric vehicle charger such as charger 180 and to supply power to one or more loads of a wireless base station such as the wireless base station of system 100. In the illustrated example, the one or more loads of the wireless base station may include any wireless base station equipment, for example, the one or more wireless base station power supplies 122, 132, 142 and one or more cellular radio components 124, 134, 144 of the wireless base station of system 100. In the illustrated example, the one or more loads of the electric vehicle charger may comprise a battery of vehicle 80 as well as charger internal loads 248 which may themselves comprise any of loads of system 200 other than the WBS loads, for example, EV charger controller 260, charging management components 230, communications components 238 including wireless communication components 233 and a wired communication components such as Ethernet communication components 235, PLC 234, security cameras 266, metrology block 205, one or more displays 207, secure payment system 262, or other EV charger components of system 200.

System 200 may be configured to merge or integrate one or more functionalities among a wireless base station and an electric vehicle charger. For example, EV Charger controller may be in operative communication with one or more controllers of WBS loads 256 and may be configured to provide access and use or conditional access and use of one or more of the one or more displays 207, security cameras 266, and communications components 238 (such as one or both of wireless communication components 233 and Ethernet communication components 235).

System 200 is configured and operable to receive electrical power from an external power supply 202 which may be, for example, a utility or other commercial power supply such as a grid power supply, an islanded power supply, or other external power source as will occur to one of skill in the art with the benefit and insight of the present disclosure. External power supply 202 supplies AC electrical power via one or more line conductors 204. In the illustrated example, one or more line conductors 204 are configured to provide three phase electrical power with a common or neutral phase. In other embodiments the one or more line conductors 204 may be differently configured to provide two-phase electrical power, single phase electrical power, or electrical power with various other phase configurations as will occur to one skilled in the art with the benefit and insight of the present disclosure.

AC-DC converter 210 receives AC electrical power from the one or more line conductors 204, converts the received AC electrical power to DC electrical power, and outputs the converted DC electrical power to transformer 222 which includes primary circuitry 220 on a primary side and synch circuitry 224 on a secondary side. Transformer 222 is configured and operable to boost received at primary side and output the boosted DC voltage to the secondary side. It shall be appreciated that transformer 222 is an example of an isolated DC-DC converter and that other types of isolated DC-DC converters may also be utilized in other embodiments.

The boosted DC voltage form the secondary side of transformer 222 is provided to charging management components 230 which may include protection circuitry, communication circuitry configured to interface with a battery management system BMS or other control electronics of vehicle 80, and charging controls configured to regulate current and/or voltage applied to charging connector 232 to charge charging of vehicle 80 which may be operatively coupled with charging connector 232. Charging management components 230 may include one or more programmable logic controllers (PLC) such as PLC 234 which may be configured and operable to provide the aforementioned and other operational capabilities. Charging connector 232 provides a pilot signal 236 to PLC 234 indicating a connectivity state of charging connector 232 and vehicle 80 which may a.

EV charger controller 260 is operatively coupled with communications components 238 which includes wireless communication 233 and Ethernet base communication 235. Controller 260 is also operatively coupled with security cameras 266, secure payment system 262, one or more displays 207, and metrology block 205.

In some embodiments the one or more displays 207 may include a combined display selectively providing display output relating to both the electric vehicle charger and the cellular base station. In some embodiments the one or more displays 207 may include a separate displays selectively providing display output relating to one of the electric vehicle charger and the cellular base station, respectively.

Metrology block 205 is configured and operable to measure or meter power consumed during operation of system 200 to charge a battery of vehicle 80 as well as a number of other functions including, for example, calculating energy billing consumption, managing the safety switching and low-level communications to vehicle 80, monitoring temperature-to enable safety and anomaly detection. Metrology block 205 is also operatively coupled with signal conditioning block 206 and sensors block 203 which provide inputs from which metrology block 205 measures or meters power consumption.

Transformer 241 includes primary circuitry 240 on a primary side which is operatively coupled with and configured to receive DC output voltage of transformer 222. Transformer 241 includes synch circuitry 242 on a first secondary side and synch circuitry 250 on a second secondary side. Transformer 241 is configured to supply a first stepped-down voltage at its first secondary side to DC-DC converter 244 which supplies the stepped-down voltage to DC voltage source 246 which, in turn supplies the stepped-down voltage to charger internal loads 248. Transformer 241 is further configured to supply a second stepped-down voltage at its second secondary side to DC-DC converter 252 which supplies the stepped-down voltage to DC voltage source 254 which, in turn supplies the stepped-down voltage to wireless base station loads 256. Wireless bases station metering circuitry 251 is provided to meter power consumption by wireless base station loads 256 and provide information of the same to metrology block 205. It shall be appreciated that transformer 241 is an example of an isolated DC-DC converter and that other types of isolated DC-DC converters may also be utilized in other embodiments.

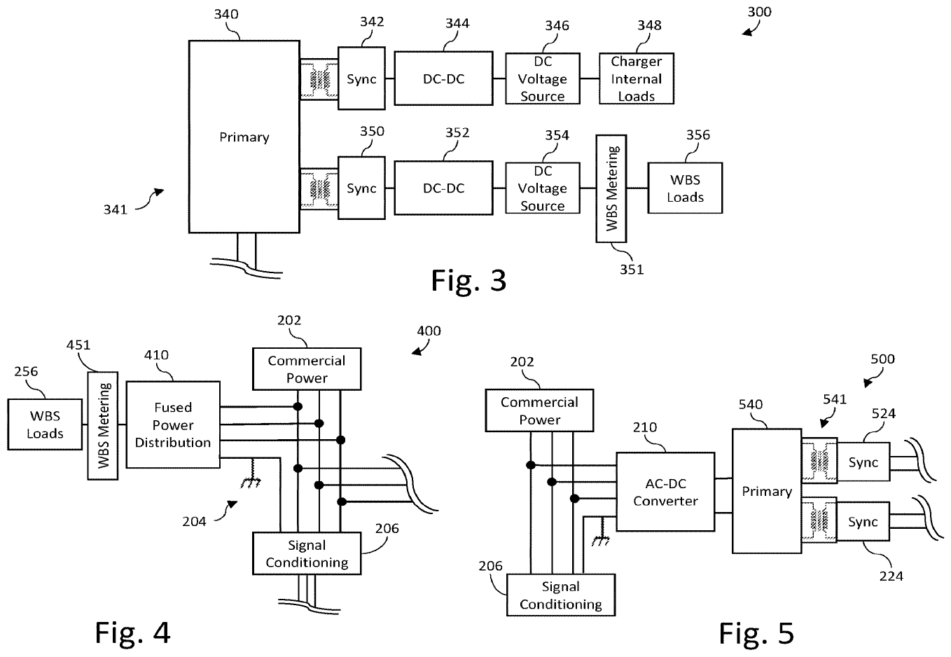

With reference to FIG. 3, there is illustrated a portion of an example electrical power supply system 300 (also referred to herein as system 300) configured to supply power to one or more loads of an electric vehicle charger such as charger 180 and to supply power to one or more loads of a wireless base station such as the wireless base station of system 100. It shall be appreciated that system 300 represents an example variation of system 200 and may include the elements and functionalities described in connection with system 200 with certain modifications.

In one respect, system 300 includes a transformer 341 including primary circuitry 340 on a primary side which is operatively coupled with and configured to receive DC receive DC output voltage of a transformer such as transformer 222. Transformer 341 includes synch circuitry 342 on a first secondary side and synch circuitry 350 on a second secondary side. Transformer 341 is configured to supply a first stepped-down voltage at its first secondary side to DC-DC converter 344 which supplies the stepped-down voltage to DC voltage source 344 which, in turn supplies the stepped-down voltage to charger internal loads 348. Transformer 341 is further configured to supply a second stepped-down voltage at its second secondary side to DC-DC converter 352 which supplies the stepped-down voltage to DC voltage source 354 which, in turn supplies the stepped-down voltage to wireless base station loads 356. Wireless bases station metering circuitry 351 is provided to meter power consumption by wireless base station loads 356 and provide information of the same to metrology components such as metrology block 205. It shall be appreciated that transformer 341 is an example of an isolated DC-DC converter and that other types of isolated DC-DC converters may also be utilized in other embodiments.

With reference to FIG. 4, there is illustrated a portion of an example electrical power supply system 400 (also referred to herein as system 400) configured to supply power to one or more loads of an electric vehicle charger such as charger 180 and to supply power to one or more loads of a wireless base station such as the wireless base station of system 100. It shall be appreciated that system 400 represents an example variation of system 200 and may include the elements and functionalities described in connection with system 200 with certain modifications.

In one respect, system 400 includes fused power distribution panel 410 which are operatively coupled with and supplied with AC power from line conductors 204. Fused power distribution panel 410 are further configured to supply AC power to wireless base station loads 256 or may include an AC-DC converter to supply wireless base station loads 256 with DC power. Wireless bases station metering circuitry 451 is provided to meter power consumption by wireless base station loads 256 and provide information of the same to metrology block 205.

With reference to FIG. 5, there is illustrated a portion of an example electrical power supply system 500 (also referred to herein as system 500) configured to supply power to one or more loads of an electric vehicle charger such as charger 180 and to supply power to one or more loads of a wireless base station such as the wireless base station of system 100. It shall be appreciated that system 500 represents an example variation of system 200 and may include the elements and functionalities described in connection with system 200 with certain modifications.

In one respect, system 500 includes a transformer 541 including primary circuitry 540 on a primary side which is operatively coupled with and configured to receive DC receive DC output of AC-DC converter 210. Transformer 541 includes primary circuitry 540 on a primary side, synch circuitry 224 on a first secondary side and synch circuitry 524 on a second secondary side. Transformer 541 is configured to supply a boosted voltage at its first secondary side to DC-DC converter 244 as described above. Transformer 341 is further configured to supply a second stepped-down voltage at its second secondary side to power wireless base station loads such as wireless base station loads 256. It shall be appreciated that transformer 541 is an example of an isolated DC-DC converter and that other types of isolated DC-DC converters may also be utilized in other embodiments.

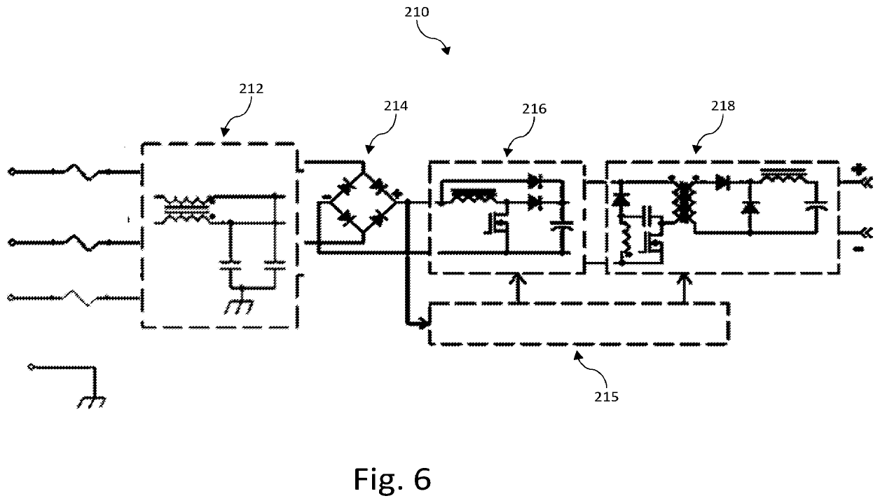

With reference to FIG. 6, there is illustrated an example AC-DC converter 210 which is configured to receive a three-phase AC input 211, filter the received input using an EMI filter 212, rectify the filtered AC input using a rectifier bridge 214, perform power factor correction (PFC) on the rectified input using a PFC preregulator 216, boost the rectified PFC-corrected input using a DC-DC converter 218, and provide a DC output 219. AC-DC converter 210 further includes a housekeeping power supply 215 which is powered by the output of rectifier 214, and supplies power to PFC preregulator 216 and DC-DC converter to update.

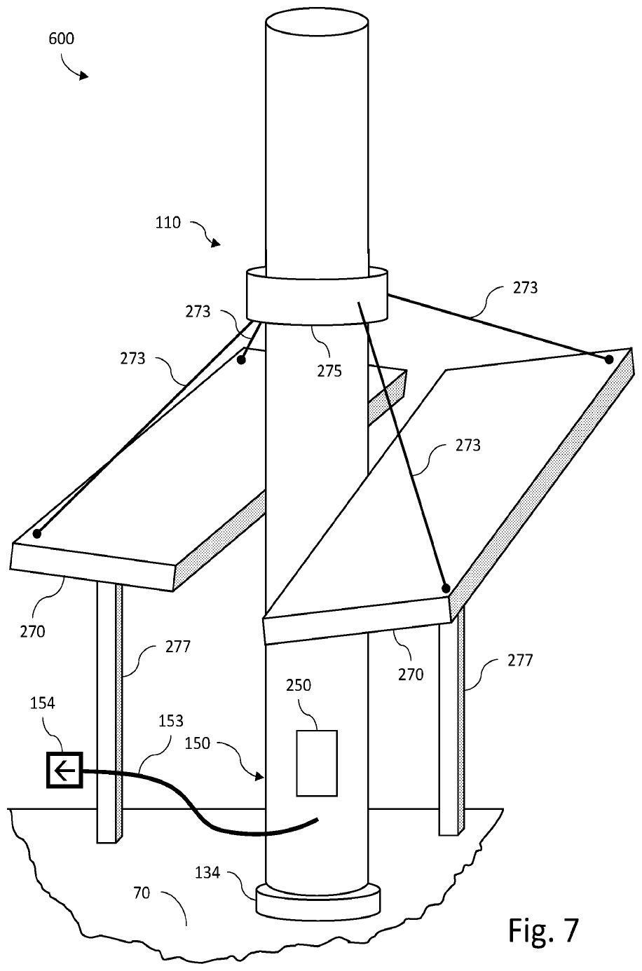

With reference to FIG. 7, there is illustrated another example integrated wireless base station and electric vehicle (EV) charging station system 600 (also referred to herein as system 600). System 600 may include substantially the same features as those of system 100 illustrated and several such features are denoted with the same reference numerals used in connection with system 100.

In one respect, system 700 further includes a plurality of solar arrays and associated supports 270 which are configured to provide electrical power to system 600. As illustrated in FIG. 7, each of the plurality of solar arrays and associated supports 270 may is supported in part by couplings 273, 275 extending to and coupled with housing 110 of system 100 and in part by ground contacting pillars or columns 277. In other embodiments, the plurality of solar arrays and associated supports 270 may is supported solely by couplings extending to and coupled with housing 110 of system 100 or solely by ground contacting pillars or columns.

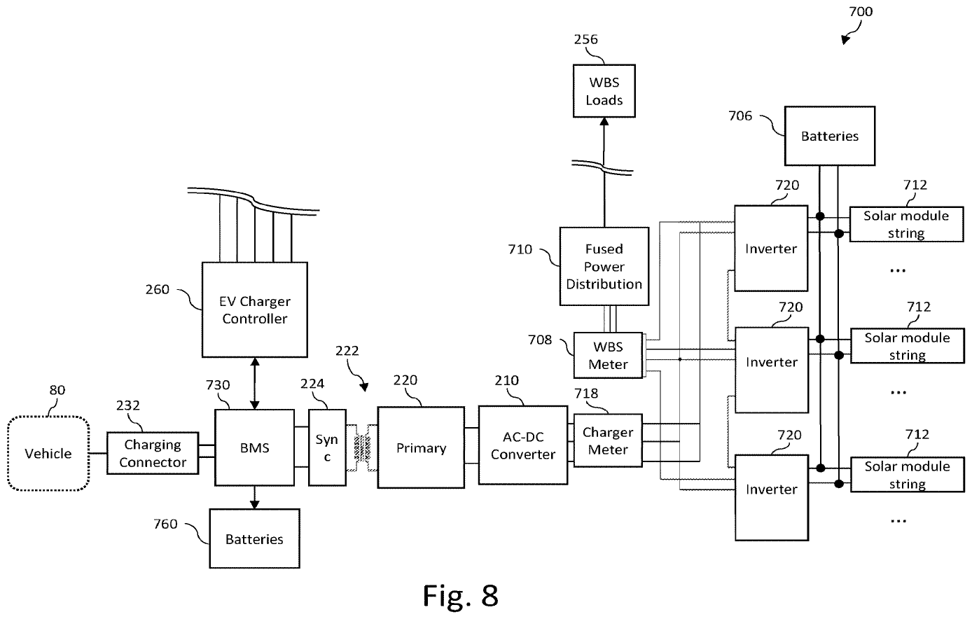

With reference to FIG. 8, there is illustrated a portion of an example electrical power supply system 700 (also referred to herein as system 700) configured to supply power to one or more loads of an electric vehicle charger such as charger 180 and to supply power to one or more loads of a wireless base station such as the wireless base station of system 100. It shall be appreciated that system 700 represents an example variation of system 200 and may include the elements and functionalities described in connection with system 200 with certain modifications.

In one respect, system 700 includes a solar power system comprising a plurality of solar module strings 712 operatively coupled a plurality of inverters 720. A wireless base station meter 708 is operatively coupled with the plurality of inverters 720 and is configured to meter electrical power supplied to wireless base station loads 256 via fused power distribution panel 710. A charger meter 718 is operatively coupled with the plurality of inverters 720 and is configured to meter electrical power supplied to AC-DC converter 220 of the electric vehicle charger and ultimately to a battery of vehicle 80 via charging connector 232.

System 700 may comprises one or more batteries 706 operatively coupled with the one or more inverters 720 and configured to supply power to the one or more inverters 720 to power at least one of the electric vehicle charger and the wireless base station. It shall be appreciated that the one or more batteries 706 may be configured to supply electrical power to supplement or replace electrical power provided by solar module strings 712. System 700 may also comprise a battery management system 730 and operatively coupled with charging connector 232 and operatively coupled with the first isolated DC-DC converter 222 which is operatively coupled with the AC-DC converter 210. One or more batteries 760 may be operatively coupled with the battery management system 730 and may be configured to supply electrical power to supplement or replace electrical power provided by solar module strings 712.

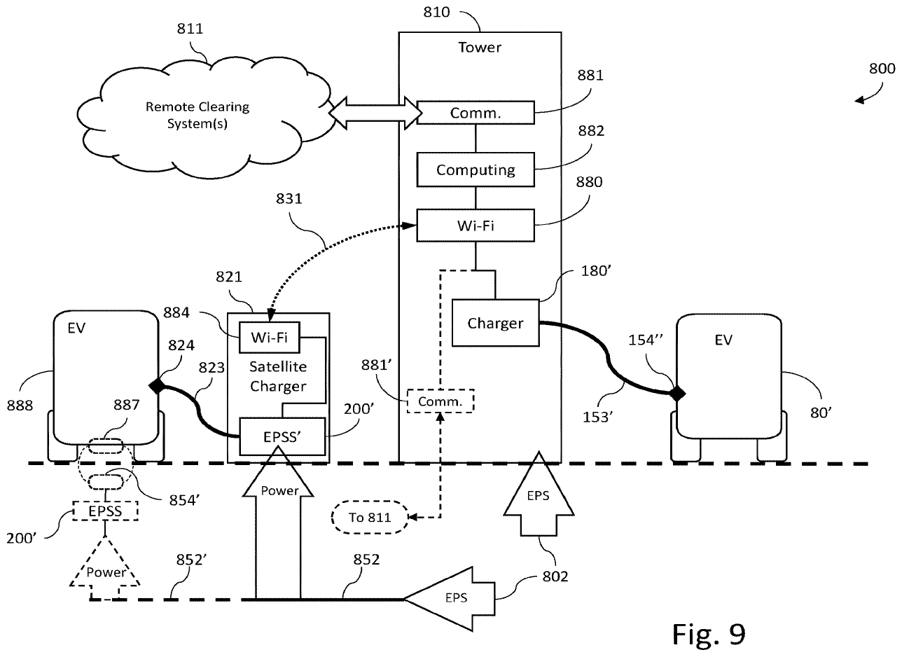

With reference to FIG. 9, there is illustrated an example integrated wireless base station and electric vehicle (EV) charging station system 800 (also referred to herein as system 800). System 800 comprises a tower 810 which may be configured and provided in the same or a substantially similar form as the tower illustrated and described in connection with system 100 and the other example embodiments illustrated and described herein. For example, tower 810 may be configured and provided as a structure including one or more of the housings, bases, support frames, exterior shell sections or panels, compartments, and interior portions described and illustrated in connection with other embodiments examples herein. Tower 810 may further be provided as a freestanding structure including one or more of the aforementioned features. Tower 810 may further comprise chargers, charging connectors, charging cables, antennae, power supplies, cellular radio components, and other attributes, components, devices, environment, systems, and other features described and illustrated herein. It shall be appreciated that the attributes, components, devices, environment, systems, and other features described and illustrated in connection with systems 100, 100′, 200, 300, 400, 500, 600, and/or system 700 may Obe included in tower 810 with such necessary or desirable adaptations and modifications as will occur to one of skill in the art with the benefit and insight of the present disclosure.

In the illustrated example, tower 810 comprise charger 180′ which may be configured and provided in the form of and with the functionality of charger 180 which is illustrated and described herein above. Charger 180′, charging cable 153′, and charging connector 154″ may be utilized in charging EV 80′ in a manner substantially similar to the charging of EV 80 using charger 180, charging cable 153, and charging connector 154.

Tower 810 may also participate in EV charging in conjunction with satellite charger 821. In some embodiments, tower 810 may participate in charging a plurality of EV in conjunction with a plurality of satellite chargers. The plurality of satellite chargers may be of the same or similar type as satellite charger 821, simplified satellite charger 921, ultra-simplified satellite charger 1021 (which are further described herein below), other types of satellite charger as will occur to one of skill in the art with the benefit and insight of the present disclosure, and/or combinations of any two or more of the foregoing types of satellite chargers. In some embodiment, charger 180′ may be omitted and tower 810 may participate in EV charging in conjunction with a satellite charger or a plurality of satellite chargers of the aforementioned forms or combinations of forms.

Tower 810 is provided with a Wi-Fi system 880 which may be housed or contained within tower 810. Wi-Fi system 880 is configured and operable to wirelessly communicate with other electronic communication systems and components of system 800. It shall be appreciated that Wi-Fi system 880 may be configured and provided in the form of a number of other types of wireless communication systems using a number of other wireless communication components, devices, systems, techniques and protocols as will occur to one of skill in the art with the benefit and insight of the present disclosure.

Tower 810 is further provided with computing system 882 which may be housed or contained within tower 810. Computing system 882 may comprise a server configured and operable to establish and manage a wireless network in conjunction with Wi-Fi system 880. In some forms, computing system 882 may cooperate with other remotely located computing components and/or resources to provide a virtual server functionality thereby reducing the computational burden at the site of tower 810. Computing system 882 may also participate in authorizing charging events and/or clearing payments via its server component(s) or via other component(s).

Tower 810 is further provided with communication system 881 and/or communication system 881′ one or both of which may be housed or contained within tower 810. Communication system 881 is configured and provided as a wireless communication system comprising components such as those described in connection with system 100. Communication system 881 may comprise, for example, a wireless base station such as described in connection with system 100 which may comprising one or more antenna, one or more wireless base station power supplies, and one or more cellular radio components. Additionally or alternatively, communication system 881 may comprise a point to point (P2P) wireless communication system, such as a microwave relay link or other P2P wireless communication systems as will occur to one of skill in the art with the benefit and insight of the present disclosure.

Communication system 881′ may comprise one or more physical communication links and associated communication devices, for example, fiber optic cabling in combination with a optical-electronic interface. Communication system 881′ may be provided and present in place of or in combination with communication system 881. Either or both of communication system 881 and communication system 881′ may by configured to provide operative communication with one or more remote clearing systems 811 for purposes of authorizing charging events and/or clearing payments, providing virtual server functionality in conjunction with computing system 882, or a number of other communication purposes as will occur to one of skill in the art with the benefit and insight of the present disclosure.

As illustrated in FIG. 9, Wi-Fi system 880 is configured and operable to wirelessly communicate with Wi-Fi system 884 of satellite charger 821 via wireless communication link 831. Wi-Fi system 880 may be contained in a common housing with other components of satellite charger 821 or may be otherwise physically coupled with satellite charger 821 or otherwise collocated with or operatively coupled with satellite charger 821.

Satellite charger 821 includes electrical power supply system (EPSS) 200′ which is operatively coupled with an external power supply 802 by one or more power lines 852 and is operatively coupled with charging cable 823 and charging connector 824 which, in turn, may be selectably operatively coupled with EV 888 to charge a battery thereof. External power supply 802 may be, for example, a utility or other commercial power supply such as a grid power supply, an islanded power supply, or other external power source as will occur to one of skill in the art with the benefit and insight of the present disclosure.

As illustrated in phantom in FIG. 9, a wireless charging system may be provided in lieu of satellite charger 821 includes electrical power supply system (EPSS) 200′ which may comprise a terrestrial or subterranean inductive charger portion 854′ and a vehicle based inductive charger portion 887. Inductive charger portion 854′ may be powered by EPSS 200′ which is supplied with power form external power supply 802 via power lines 852, 852′ or by another power supply system as will occur to one of skill in the art with the benefit and insight of the present disclosure.

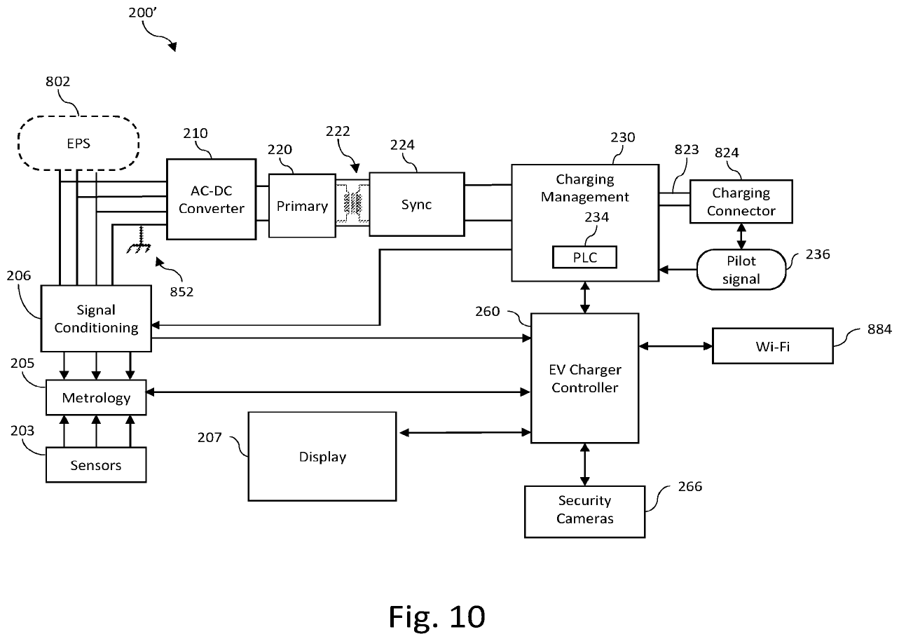

Referring now to FIG. 10, there are illustrated further details of an example embodiment of EPSS 200′. As also illustrated in FIG. 10, EPSS 200′ is configured and operable to receive power from external power supply 802 via power lines 852 which are depicted in a three phase form in the illustrated embodiment but may also be provided in different forms with a different number of phases.

EPSS 200′ comprises a streamlined subset of the components and connectivity of system 200 which is illustrated and described in connection with FIG. 2, wherein the other components of system 200 may be omitted, removed or otherwise not present in EPSS 200′. In the illustrated example, EPSS 200′ may comprise or may consist essentially of AC-DC converter 210, transformer 222 which includes primary circuitry 220 on a primary side and synch circuitry 224 on a secondary side to provide DC-DC conversion (or alternatively another type of isolated DC-DC converters may utilized), charging management components 230 which may include PLC 234 or other control components, EV charger controller 260, signal conditioning block 206, metrology block 205, and sensors block 203. EPSS 200′ further comprises the functionalities and control and processing aspects of the foregoing components as further described in connection with system 200.

As depicted in the illustrated example, EPSS 200′ may optionally further comprise or be operatively coupled with one or more displays 207. In lieu of displays 207 an external display such as a display of EV 888 or a drivers smart phone in operative wireless communication with EPSS 200′ via WI-FI system 884 may be utilized. As further depicted in the illustrated example, EPSS 200′ may optionally further comprise or be operatively coupled with one or more security cameras 266 which may also be omitted or provided elsewhere or in connection with other systems.

In the embodiment of FIGS. 9 and 10, satellite charger 821 is provided in an intelligent form and includes the functionalities and control and processing aspects of EPSS 200′. On the other hand, one or more intelligence aspects may be omitted from satellite charger 821. For example, secure payment authorization and clearance may be provided via operative communication of Wi-Fi system 884 with Wi-Fi system 880 in association with computing system, and communication system 881 (or alternatively communication system 881′) of tower 810 in operative communication with remote clearing system 811.

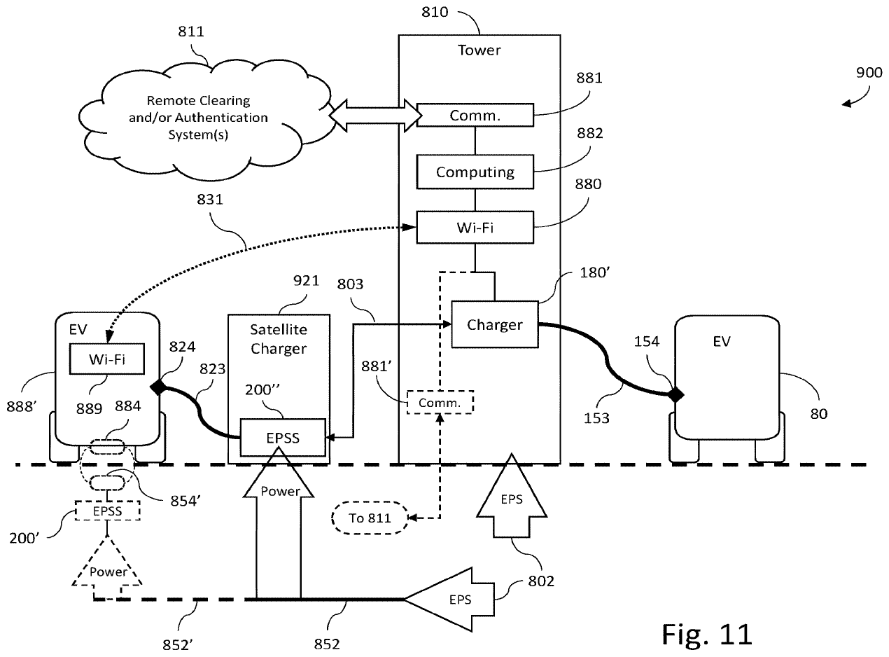

Referring now to FIG. 11, there is illustrated an example integrated wireless base station and electric vehicle (EV) charging station system 900 (also referred to herein as system 900). System 900 includes a number of features which are the same as or substantially similar to corresponding features of system 800 and which are labeled with the same reference numerals utilized in the illustration and description of system 800. It shall be appreciated that the connectivity, structure, and functionality of such like numbered features of system 900 may be the same as or substantially similar to those of system 800 with such necessary or desirable adaptations and modifications as will occur to one of skill in the art with the benefit and insight of the present disclosure.

System 900 also differs from system 800 in certain respects. In one aspect, system 900 comprises a simplified satellite charger 921 in lieu of satellite charger 821. Furthermore, simplified satellite charger 921 comprises electrical power supply system (EPSS) 200″ in lieu of EPSS 200′.

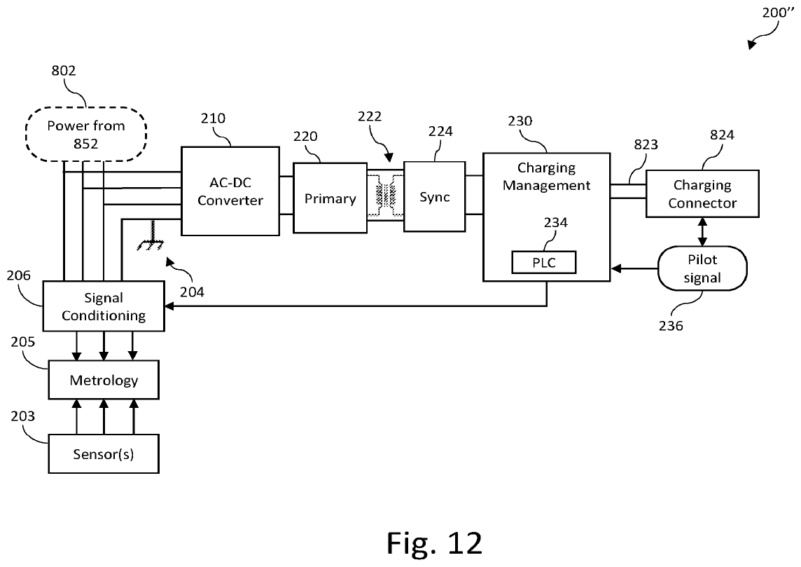

With further reference to FIG. 12, EPSS 200″ comprises a streamlined subset of the components and connectivity of EPSS 200′, wherein the other components of system 200 may be omitted, removed or otherwise not present in EPSS 200′. For example, EPSS 200″ may comprise or may consist essentially of AC-DC converter 210, transformer 222 including primary circuitry 220 on a primary side and synch circuitry 224 on a secondary side to provide DC-DC conversion (or alternatively another type of isolated DC-DC converters may utilized), charging management components 230 which may include PLC 234 or other control components, signal conditioning block 206, metrology block 205, and sensors block 203.

In the embodiment of FIGS. 11 and 12, simplified satellite charger 921 is provided in a simplified form and includes the functionalities and control and processing aspects of EPSS 200″ while omitting certain features of EPSS functionalities and control and processing aspects including those relating to EV charger controller 230. For example, EV charger controller 260 and its associated functionality are omitted from EPSS 200″ of simplified satellite charger 921. The functionality of EV charger controller 260 may instead be provided in tower 810

In some embodiments, tower 810 may be provided with a multi-charger controller which is conceptually similar to EV charger controller 260, but is adapted to control charging of one or more satellite chargers. Such a multi-charger controller may be implemented in connection with charger 180′ or as one or more separate controllers, control components, or control units.

A communication links 803 is configured and operable to provide bidirectional communication between the multi-charger controller and EPSS 200′. The bi-directional communication link 803 may be, for example, fieldbus-type communication link or another type of time critical communication link, a wireless communication link, or other types of communication links as will occur to one of skill in the art with the benefit and insight of the present disclosure. Additionally, secure payment authorization and clearance may be omitted from simplified satellite charger 921 and may instead may be provided via operative communication of Wi-Fi system 889 on-board EV 888′ with Wi-Fi system 880 in association with computing system, and communication system 881 (or alternatively communication system 881′) of tower 810 in operative communication with remote clearing system 811.

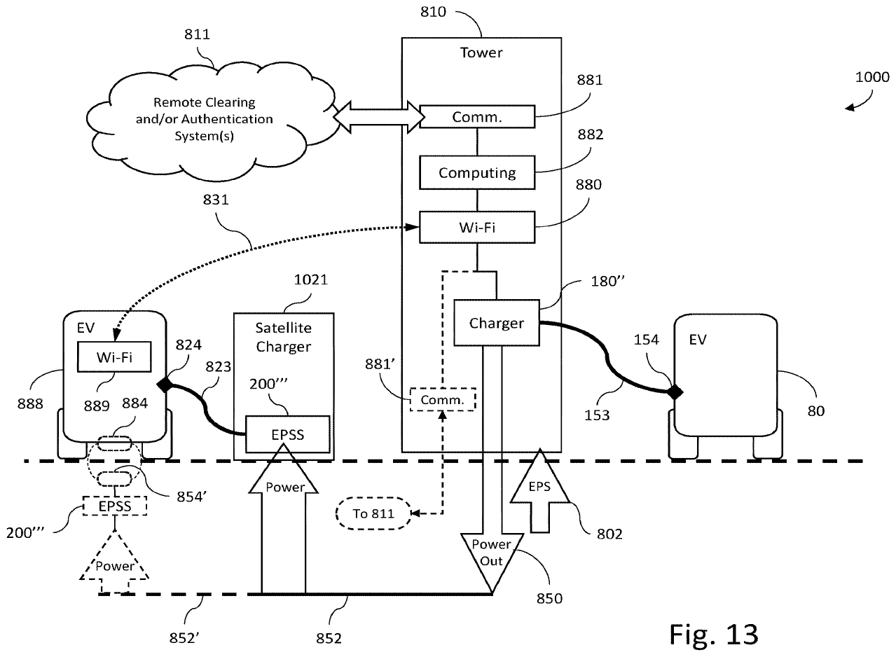

Referring now to FIG. 13, there is illustrated an example integrated wireless base station and electric vehicle (EV) charging station system 1000 (also referred to herein as system 1000). System 1000 includes a number of features which are the same as or substantially similar to corresponding features of system 800 and system 900 and which are labeled with the same reference numerals utilized in the illustration and description of system 800 and system 900. It shall be appreciated that the connectivity, structure, and functionality of such like numbered features of system 1000 may be the same as or substantially similar to those of system 800 and system 900 with such necessary or desirable adaptations and modifications as will occur to one of skill in the art with the benefit and insight of the present disclosure.

System 1000 also differs from system 800 and system 900 in certain respects. In one aspect, system 900 comprises an ultra-simplified satellite charger 1021 in lieu of simplified satellite charger 921. Furthermore, ultra-simplified satellite charger 1021 comprises electrical power supply system (EPSS) 200′″ in lieu of EPSS 200″.

EPSS 200′″ is provided with power from charger 180″ which receives power from external power supply 802 and regulates and controls power output 850 to EPSS 200′″ via one or more power supply lines 852. Charger 180″ may be of a form similar to charger 180 but expanded in scale to service one or multiple satellite chargers such as ultra-simplified satellite charger 1021. Charger 180″ may control regulate, and meter power provided to ultra-simplified satellite charger 1021 and EPSS 200′″ and as well other instances of similar components.

Ultra-simplified satellite charger 1021 may comprise no computing capability, and may comprise no or minimal control capabilities which may be provided EPSS 200′″. For example, EPSS 200′″ may comprise only one or more safety devices, for example, fuse(s), fault interrupter(s) and/or or circuit breaker(s). In such embodiments, power The safety device may in principle be entirely passive and may include only fuse(s), mechanical circuit breakers or fault interrupters, and or passive galvanic isolation components such as transformer(s). In such embodiments, charger 180″ may solely control, regulate, and meter power provided to ultra-simplified satellite charger 1021 and EPSS 200″ for charging EV 888′.

A number of non-limiting example embodiments shall now be described. A first example, embodiment is a system comprising: a housing comprising a base configured to couple with a ground anchor and a support frame coupled with and extending upward from the base; an electric vehicle charger housed by a first interior portion of the housing; a wireless base station housed by a second interior portion of the housing; and an electrical power supply system configured to supply power to the electric vehicle charger via a first conductor and to supply power to the wireless base station via a second conductor.

A second example embodiment includes the features of the first example embodiment, wherein the power system comprises: an AC-DC converter configured to convert AC power from a source external to the system to DC power, a first isolated DC-DC converter coupled with the AC-DC converter and configured to convert a first DC voltage to a second DC voltage, and an electric vehicle (EV) charging connector powered by the second DC voltage and configured to operatively couple with an electric vehicle charging connector.

A third example embodiment includes the features of the second example embodiment, comprising a second isolated DC-DC converter powered by the second DC voltage and configured to supply power at least to the wireless base station via the second conductor.

A fourth example embodiment includes the features of the third example embodiment, wherein the second isolated DC-DC converter comprises a second transformer comprising a first output tap and a second output tap, the first output tap being configured to supply power to a second load of the electric vehicle charger, the second output tap being configured to supply power to at least to the wireless base station via the second conductor.

A fifth example embodiment includes the features of the fourth example embodiment, wherein the second transformer comprises the first output tap and the second output tap on a common secondary.

A sixth example embodiment includes the features of the fifth example embodiment, wherein the second transformer comprises the first output tap and the second output tap on separate secondaries.

A seventh example embodiment includes the features of the second example embodiment, comprising a fused distribution panel conductively coupled with the source external to the system and configured to supply power to at least to the wireless base station via the second conductor.

An eighth example embodiment includes the features of the second example embodiment, wherein the first isolated DC-DC converter comprises a transformer comprising a first output tap and a second output tap, the first output tap being configured to supply the second DC voltage, the second output tap being configured to supply power to at least to the wireless base station via the second conductor.

A ninth example embodiment includes the features of the second example embodiment, wherein the source external to the system comprises a solar power system.

A tenth example embodiment includes the features of the ninth example embodiment, wherein the solar power system comprises a plurality of solar module strings operatively coupled with one or more inverters, a wireless base station meter operatively coupled with the one or more inverters and configured to meter electrical power supplied to wireless base station, and a charger meter operatively coupled with the one or more inverters and configured to meter electrical power supplied to the electric vehicle charger.

An eleventh example embodiment includes the features of the tenth example embodiment, comprising one or more batteries operatively coupled with the one or more inverters and configured to supply power to the one or more inverters to power at least one of the electric vehicle charger and the wireless base station.

A twelfth example embodiment includes the features of the tenth example embodiment, comprising a battery management system operatively coupled with the first isolated DC-DC converter coupled with the AC-DC converter and operatively coupled with the charging connector, and one or more batteries operatively coupled with the battery management system.

A thirteenth example embodiment includes the features of the tenth example embodiment, wherein one or more loads of the wireless base station is configured to receive AC power from the one or more inverters.

A fourteenth example embodiment includes the features of the first example embodiment, wherein the housing comprises a plurality of compartments, the electric vehicle charging system is contained at least in part in a first compartment of the plurality of compartments, and the wireless base station is contained at least in in part in a second compartment of the plurality of compartments.

A fifteenth example embodiment includes the features of the first example embodiment, comprising a controller in operative communication with one or more components of the electric vehicle charger and in operative communication with one or more components of the wireless base station.

A sixteenth example embodiment includes the features of the fifteenth example embodiment, wherein the controller is configured to provide common integrated access to one or more ancillary resources to the one or more components of the electric vehicle charger and the one or more components of the wireless base station.

A seventeenth example embodiment includes the features of the sixteenth example embodiment, wherein the one or more ancillary resources comprise one or more of a security camera, a display, a communication component.

An eighteenth example embodiment includes the features of the sixteenth example embodiment, wherein the one or more ancillary resources comprise two or more of the security camera, the display, and the communication component.

A nineteenth example embodiment includes the features of the fifteenth example embodiment, wherein the controller is configured to determine electrical power usage of the electric vehicle charger and to determine electrical power usage of the wireless base station.

A twentieth example embodiment includes the features of the sixteenth example embodiment, wherein the one or more ancillary resources comprise two or more of the security camera, the display, and the communication component.

A twenty-first example embodiment includes the features of the twentieth example embodiment, wherein the tower is operatively coupled with one or more satellite EV chargers.

A twenty-second example embodiment includes the features of the twenty-first example embodiment, wherein the one or more satellite EV chargers comprise a first satellite EV charger positioned at a location spaced apart from the tower, the first satellite EV charger being in operatively communication with the tower.

A twenty-third example embodiment includes the features of the twenty-second example embodiment, wherein the first satellite EV charger comprises a first wireless communication system, the tower comprises a second wireless communication system, and a wireless link is established between the first wireless communication system and the second wireless communication system.

A twenty-fourth example embodiment includes the features of the twenty-third example embodiment, wherein the first wireless communication system and the second wireless communication system are configured authorize a charging event using the wireless link.

A twenty-fifth example embodiment includes the features of the twenty-third example embodiment, wherein the first wireless communication system and the second wireless communication system are configured clear payment for a charging event using the wireless link.

A twenty-sixth example embodiment includes the features of the twenty-third example embodiment, wherein the first wireless communication system comprises a first Wi-Fi transceiver, the second wireless communication system comprises a second Wi-Fi transceiver, and the wireless link comprises a Wi-Fi network.

A twenty-seventh example embodiment includes the features of the twenty-second example embodiment, wherein the first satellite EV charger does not include and is not connected to a physical communication link.

A twenty-eighth example embodiment includes the features of the twenty-second example embodiment, wherein the one or more satellite EV chargers comprise: a second satellite EV charger positioned at a second location spaced apart from the tower, the second satellite EV charger being operatively coupled with an electric vehicle.

A twenty-ninth example embodiment includes the features of the twenty-eighth example embodiment, wherein the electric vehicle comprises a third wireless communication system, the tower comprises a second wireless communication system, and a second wireless link is established between the third wireless communication system and the second wireless communication system.

A thirtieth example embodiment includes the features of the twenty-ninth example embodiment, wherein the third wireless communication system and the second wireless communication system are configured authorize a charging event using the second wireless link.

A thirty-first example embodiment includes the features of the twenty-ninth example embodiment, wherein the third wireless communication system and the second wireless communication system are configured clear payment for a charging event using the second wireless link.

A thirty-second example embodiment includes the features of the twenty-first example embodiment, wherein the one or more satellite EV chargers comprise a satellite EV charger positioned at a location spaced apart from the tower, the satellite EV charger being charger being operatively coupled with an electric vehicle.

A thirty-third example embodiment includes the features of the thirty-second example embodiment, wherein the electric vehicle comprises a first wireless communication system, the tower comprises a second wireless communication system, and a wireless link is established between the first wireless communication system and the second wireless communication system.

A thirty-fourth example embodiment includes the features of the thirty-third example embodiment, wherein the first wireless communication system and the second wireless communication system are configured authorize a charging event using the wireless link.

A thirty-fifth example embodiment includes the features of the thirty-third example embodiment, wherein the first wireless communication system and the second wireless communication system are configured clear payment for a charging event using the wireless link.

A thirty-sixth example embodiment includes the features of the thirty-third example embodiment, wherein the first wireless communication system comprises a first Wi-Fi transceiver, the second wireless communication system comprises a second Wi-Fi transceiver, and the wireless link comprises a Wi-Fi network.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A system comprising:
a tower comprising a housing comprising a base configured to couple with a ground anchor and a support frame coupled with and extending upward from the base;
an electric vehicle charger housed by a first interior portion of the housing;
a wireless base station housed by a second interior portion of the housing; and
an electrical power supply system configured to supply power to the electric vehicle charger via a first conductor and to supply power to the wireless base station via a second conductor.

2. The system of claim 1, wherein the electric vehicle charger comprises:
an AC-DC converter configured to convert AC power from a source external to the system to DC power,
a first isolated DC-DC converter coupled with the AC-DC converter and configured to convert a first DC voltage to a second DC voltage, and
an electric vehicle charging connector powered by the second DC voltage and configured to operatively couple with an electric vehicle charging connector.

3. The system of claim 2, comprising a second isolated DC-DC converter powered by the second DC voltage and configured to supply power at least to the wireless base station via the second conductor.

4. The system of claim 3, wherein the second isolated DC-DC converter comprises a second transformer comprising a first output tap and a second output tap, the first output tap being configured to supply power to a second load of the electric vehicle charger, the second output tap being configured to supply power to at least to the wireless base station via the second conductor.

5. The system of claim 4, wherein the second transformer comprises the first output tap and the second output tap on a common secondary.

6. The system of claim 5, wherein the second transformer comprises the first output tap and the second output tap on separate secondaries.

7. The system of claim 2, comprising a fused distribution panel conductively coupled with the source external to the system and configured to supply power to at least to the wireless base station via the second conductor.

8. The system of claim 2, wherein the first isolated DC-DC converter comprises a transformer comprising a first output tap and a second output tap, the first output tap being configured to supply the second DC voltage, the second output tap being configured to supply power to at least to the wireless base station via the second conductor.

9. The system of claim 2, wherein the source external to the system comprises a solar power system.

10. The system of claim 9, wherein the solar power system comprises a plurality of solar module strings operatively coupled with one or more inverters, a wireless base station meter operatively coupled with the one or more inverters and configured to meter electrical power supplied to wireless base station, and a charger meter operatively coupled with the one or more inverters and configured to meter electrical power supplied to the electric vehicle charger.

11. The system of claim 10, comprising one or more batteries operatively coupled with the one or more inverters and configured to supply power to the one or more inverters to power at least one of the electric vehicle charger and the wireless base station.

12. The system of claim 10, comprising a battery management system operatively coupled with the first isolated DC-DC converter coupled with the AC-DC converter and operatively coupled with the electric vehicle charging connector, and one or more batteries operatively coupled with the battery management system.

13. The system of claim 10, wherein one or more loads of the wireless base station is configured to receive AC power from the one or more inverters.

14. The system of claim 1, wherein the housing comprises a plurality of compartments, the electric vehicle charger is contained at least in part in a first compartment of the plurality of compartments, and the wireless base station is contained at least in in part in a second compartment of the plurality of compartments.

15. The system of claim 1, comprising a controller in operative communication with one or more components of the electric vehicle charger and in operative communication with one or more components of the wireless base station.

16. The system of claim 15, wherein the controller is configured to provide common integrated access to one or more ancillary resources to the one or more components of the electric vehicle charger and the one or more components of the wireless base station.

17. The system of claim 16, wherein the one or more ancillary resources comprise one or more of a security camera, a display, a communication component.

18. The system of claim 17, wherein the one or more ancillary resources comprise two or more of the security camera, the display, and the communication component.

19. The system of claim 15, wherein the controller is configured to determine electrical power usage of the electric vehicle charger and to determine electrical power usage of the wireless base station.

20. The system of claim 17, wherein the one or more ancillary resources comprise two or more of the security camera, the display, and the communication component.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)
